(19) United States
(12) Patent Application Publication
(10) Pub. No.: US 2015/0334299 A1
(43) Pub. Date: Nov. 19, 2015

(54) MONITORING SYSTEM

(71) Applicant: PANASONIC INTELLECTUAL PROPERTY MANAGEMENT CO., LTD., OSAKA (JP)

(72) Inventors: Masashige TSUNENO, Fukuoka (JP); Koji KAWAMOTO, Fukuoka (JP)

(73) Assignee: PANASONIC INTELLECTUAL PROPERTY MANAGEMENT CO., LTD., OSAKA (JP)

(21) Appl. No.: 14/277,278

(22) Filed: May 14, 2014

(51) Int. Cl. H04N 5/232; G06K 9/00; G06T 7/20

(52) U.S. Cl. CPC H04N 5/23238; H04N 5/23293; G06T 7/20; G06K 9/00228; G06K 9/00288; G06T 2207/10016; G06T 2207/30232; G06T 2207/30196

(57) ABSTRACT

A monitoring system includes a stationary camera, an omni-directional camera, and image processing apparatus and a display unit. The stationary camera captures an image in a predetermined imaging range. The omni-directional camera captures an image in an omni-directional imaging area including the predetermined imaging range. The image processing apparatus detects a predetermined event in first image data generated from the image in the predetermined imaging range captured by the stationary camera. In a case where the predetermined event is detected in the predetermined imaging range of the first image data, the display unit displays the first image data and second image data generated from the image in the omni-directional imaging area captured by the omni-directional camera and includes the predetermined imaging range from which the predetermined event is detected.

### BACKGROUND

1. Field of the Invention

The present invention relates to a monitoring system for displaying image data captured by a stationary camera and an omni-directional camera on a monitoring screen.

2. Description of the Related Art

In recent years, with an increase of a monitoring area which is a monitoring target by a monitoring system and an increase of scale in the monitoring system, a requirement for labor saving and automation in a monitoring task has increased in order to improve efficiency of the monitoring task which, in the related art, relies on an observer, that is a person. For example, in addition to a display of the image data transmitted from one or more monitoring cameras on the screen of the monitor client, by providing an image processing apparatus and analyzing the image data in the image processing apparatus, a monitoring system emerges that presents a position and a time to the observer, at which a certain phenomenon (hereinafter, referred to as “event”) occurs.

Here, as a related technology by which an intruding object is enlarged and displayed without a blind angle, using a minimum number of cameras by linking a plurality of cameras, a monitoring apparatus is known, in which the cameras are linked as indicated in JP-A-2004-343718.

The monitoring apparatus in which the cameras are linked in JP-A-2004-343718 traces the position of the intruding object by performing the image processing with respect to the image data from a plurality of rotation cameras of which panning, tilting, and zooming are controllable, assigns a tracing function to a first rotation camera of which an imaging range is in a predetermined direction of the monitoring target according to the situation of the monitoring target, and assigns a wide-area imaging function for imaging a monitoring space in a wide angle to a second rotation camera. In addition, the monitoring apparatus controls operations of the plurality of rotation cameras using the result of the assignment of the functions with respect to each rotation camera, for example, the monitoring target can be enlarged and displayed by switching between the rotation cameras that detect the monitoring target according to the direction in which the monitoring target is facing.

### SUMMARY

In a configuration in JP-A-2004-343718, the observer can specify the monitoring target object (for example, a person) subject to being traced on the screen of the monitor client. However, the rotation camera enlarges and displays the monitoring target object according to an instruction from the monitoring apparatus. For this reason, in the configuration in JP-A-2004-343718, there is a problem in that it is difficult to find a relationship between the surrounding environment at the time of monitoring when the monitoring target object is specified by the observer and the monitoring target object.

One non-limited object of the present invention is to provide a monitoring system, in a case where an event is detected, that can easily indicate the relationship visually between the surrounding environment of the monitoring target object which causes the event at the time of monitoring and the monitoring target object.

According to an aspect of the present invention, a monitoring system includes a stationary camera, an omni-directional camera, and image processing apparatus and a display unit. The stationary camera captures an image in a predetermined imaging range. The omni-directional camera captures an image in an omni-directional imaging area including the predetermined imaging range. The image processing apparatus detects a predetermined event in first image data generated from the image in the predetermined imaging range captured by the stationary camera. In a case where the predetermined event is detected in the predetermined imaging range of the first image data, the display unit displays the first image data and second image data generated from the image in the omni-directional imaging area captured by the omni-directional camera and includes the predetermined imaging range from which the predetermined event is detected.

According to the aspect of the present invention, in a case where the event is detected, it is possible to easily indicate the relationship visually between the surrounding environment of the monitoring target object which causes the event at the time of monitoring and the monitoring target object.

### BRIEF DESCRIPTION OF THE DRAWINGS

In the accompanying drawings:

FIG. 1 is a schematic diagram illustrating a system configuration of a monitoring system in an embodiment;

FIG. 2 is a block diagram illustrating an internal configuration of a stationary camera in the embodiment in detail;

FIG. 3 is a block diagram illustrating an internal configuration of an omni-directional camera in the embodiment in detail;

FIG. 4 is a block diagram illustrating a hardware configuration of a network disk recorder in the embodiment;

FIG. 5 is a block diagram illustrating a software configuration of a control unit of the network disk recorder;

FIG. 6 is a diagram of a layout of an imaging area where the monitoring system is installed, shown from a ceiling;

FIG. 7A is a diagram illustrating a transition state between a basic screen, an event screen, and a search screen;

FIG. 7B is a diagram illustrating a transition state between a basic setting screen, a camera setting screen, and a display setting screen;

FIG. 8 is a diagram illustrating a first example of the basic screen;

FIG. 9A is a diagram illustrating one panorama image data item generated such that an imaging range of the stationary camera is included in the display range as a modification example of omni-directional image data;

FIG. 9B is a diagram illustrating two panorama image data items generated such that the imaging range of the stationary camera is included in the display range as a modification example of omni-directional image data;

FIG. 10 is a diagram illustrating a second example of the basic screen;

FIG. 11 is a diagram illustrating an example of the camera setting screen;

FIG. 12 is a diagram illustrating a first example of the search screen;

FIG. 13 is a diagram illustrating a second example of the search screen;

FIG. 14 is an example of a table indicating a face detection result with respect to the omni-directional image data; and

FIG. 15 is a flow chart explaining in detail an operation order for calculating a degree of relevance of the image analysis unit.

### DETAILED DESCRIPTION

A monitoring system according to an aspect of the present invention includes: a stationary camera that captures an image in a predetermined imaging range; an omni-directional camera that captures an image in an omni-directional imaging area including the predetermined imaging range; an image processing apparatus that detects a predetermined event in first image data, wherein the first image data is generated from the image in the predetermined imaging range captured by the stationary camera; and a display unit that displays image data. In a case where the predetermined event is detected in the predetermined imaging range of the first image data, the display unit displays the first image data and second image data, wherein the second image data is generated from the image in the omni-directional imaging area captured by the omni-directional camera and includes the predetermined imaging range from which the predetermined event is detected.

In this configuration, the monitoring system captures the image in the predetermined imaging range using the stationary camera, captures the image in the omni-directional imaging range including the predetermined imaging area using the omni-directional camera, detects the predetermined event in the image data of the predetermined imaging range using the image processing apparatus, and displays the first image data generated from the image captured by the stationary camera and the second image data generated from the image captured by the omni-directional camera on the display unit. In a case where the predetermined event is detected in the predetermined imaging range in the first image data, the display unit displays the first image data and the second image data including the predetermined imaging range from which the event is detected.

In this way, in a case where the event is detected in the first image data related to the stationary camera, since the video of the surrounding environment including the imaging range of the stationary camera is captured by the omni-directional camera, it is possible for the observer to easily check how the target object (for example, the face of a specific person or the motion of a specific object) which is a cause of the detected event will move. Therefore, in a case where the event is detected, the monitoring system can easily indicate the visual relationship between the surrounding environment of the monitoring target object which causes the event at the time of monitoring and the monitoring target object.

An embodiment (hereinafter, referred to as “present embodiment”) of a monitoring system in the present invention will be described with reference to the drawings. In the present embodiment described below, an example of the monitoring system will be described, in which, with a predetermined imaging area as a monitoring target, by displaying image data of a video captured by a stationary camera and an omni⁻directional camera installed in the imaging area on a monitor client connected via a network, the situation in the imaging area is visually indicated to an observer who is a user of the monitor client.

The present invention is not limited to the monitoring system. The present invention may be expressed as each of an apparatus such as a stationary camera, an omni-directional camera, and a network disk recorder that configure the monitoring system, a method of executing an operation of each apparatus, and a program that causes the operation of a computer readable recording medium and an information processing method with respect to each apparatus to be executed.

### (System Configuration, Layout of the Imaging Area)

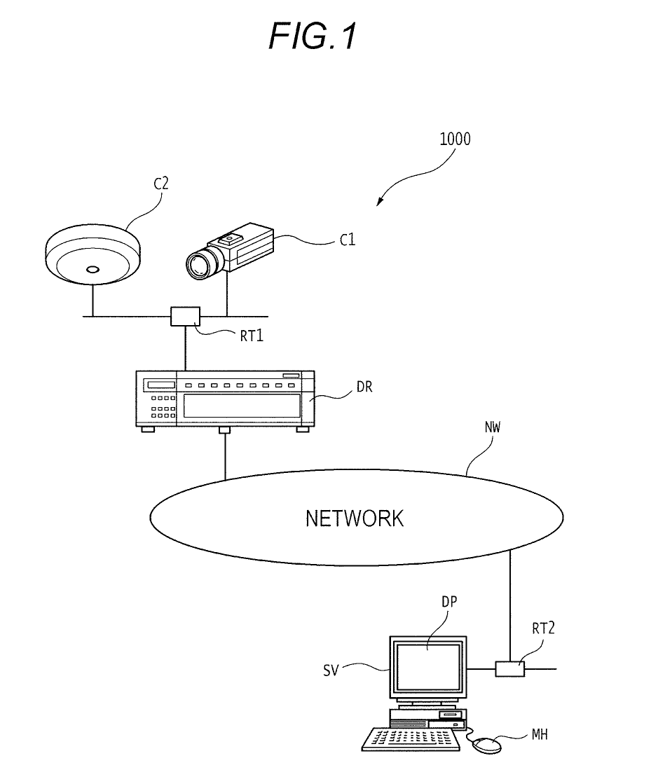

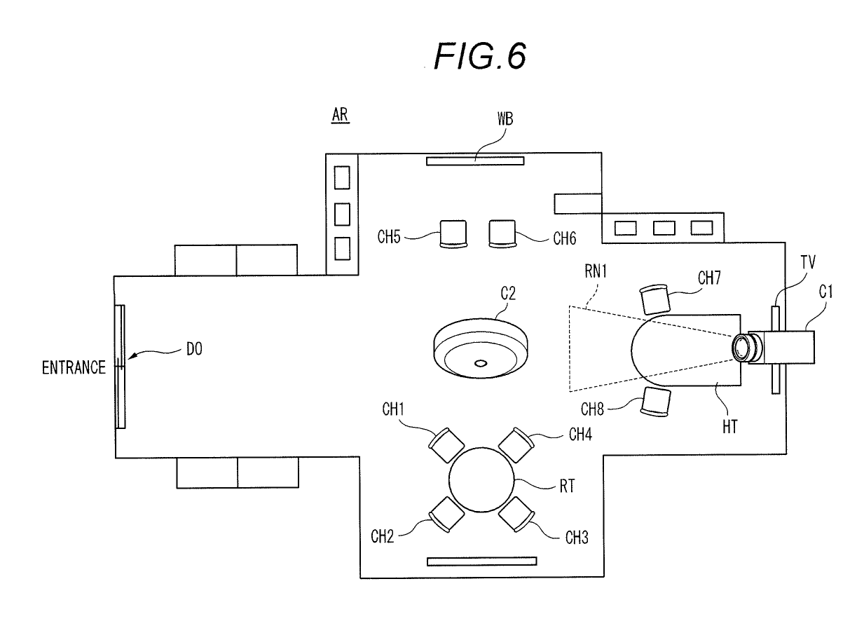

FIG. 1 is a schematic diagram illustrating a system configuration of a monitoring system 1000 in the present embodiment. FIG. 6 is a diagram of a layout of an imaging area AR where the monitoring system 1000 in the present embodiment is installed, shown from a ceiling. The monitoring system 1000 illustrated in FIG. 1 includes a stationary camera C1, an omni-directional camera C2, a network disk recorder DR, and a monitor client SV.

In the description of FIG. 6, the terms “top side”, “bottom side”, “left side”, “right side” and “center” in the imaging area AR are used when FIG. 6 is viewed sideways, with the top of the drawing on the left-hand side of the sheet. As illustrated in FIG. 6, an entrance DO to enter the imaging area AR is provided on the left side in the imaging area AR. A round table RT is disposed and four chairs CH1, CH2, CH3, and CH4 are disposed to surround the round table RT on the bottom side in the imaging area AR. On the top side in the imaging area AR, a white board WB is installed, and two chairs CH5 and CH6 are disposed so as to face the white board WB.

On the right side in the imaging area AR, a television TV is installed, a semicircular table HT is disposed in the vicinity of the television TV, and two chairs CH7 and CH8 are disposed so as to surround the semicircular table HT. In addition, on the upper side (the front side in a direction perpendicular to the sheet in FIG. 6) of the television TV, the stationary camera C1 having an imaging range RN1 in the direction facing the entrance DO from the television TV is installed. Further, at the center in the imaging area AR, on the ceiling surface of the space (for example, a room) of the imaging area AR, the omni-directional camera C2 having an imaging range of the omni-direction of the imaging area AR is installed.

In FIG. 1, the stationary camera C1, the omni-directional camera C2, and the network disk recorder DR are connected via a router RT1. The network disk recorder DR is connected to a network NW, and the monitor client SV is connected to the network NW via a router RT2. Therefore, the network disk recorder DR and the monitor client SV are connected via the network. Furthermore, the stationary camera C1, and the omni-directional camera C2 connected to the network disk recorder DR, and the monitor client SV are connected via the network NW by using a known IP network connection technology (for example, technology described in JP-A-2009-147900)

The network illustrated in FIG. 1 is, for example, a local area network (LAN) or a wide area network (WAN). In FIG. 1, the stationary camera C1 and the omni-directional camera C2 are connected to the network NW via the router RT1 and the network disk recorder DR, but may be connected to the network NW directly. In this case, the stationary camera C1 and the omni-directional camera C2 are connected to the network disk recorder DR and also connected to the network NW.

The stationary camera C1 has a fixed angle of view where the imaging range RN1 (i.e., a specific imaging range in the imaging range AR) is the direction facing the entrance DO from the television TV illustrated in FIG. 6, and images the video in the imaging range RN1 corresponding to the angle of view. The stationary camera C1 transmits the image data of the video obtained by imaging to the network disk recorder DR via the router RT1.

In addition, the stationary camera C1, in the imaging range RN1 of the imaging area AR, detects a predetermined event, and transmits the notice indicating that the predetermined event is detected to the network disk recorder DR. The predetermined event, for example, is detecting a motion of a specific object (a person) or detecting a face of a specific person, but is not limited thereto. The predetermined event may be detected by the stationary camera C1 or may be detected by an image analysis unit 204 of the network disk recorder DR described below.

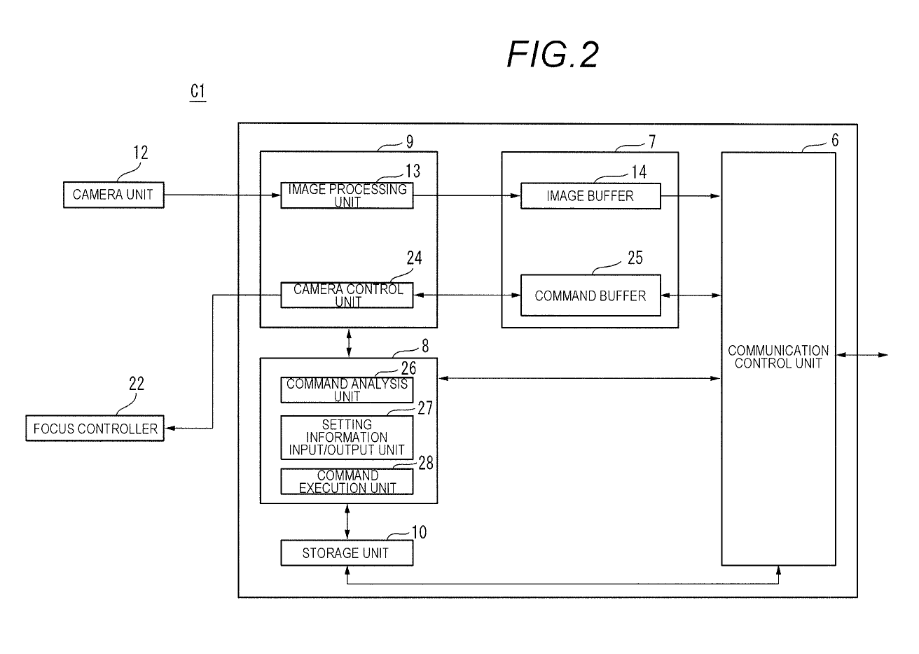

A range of detection of the event by the stationary camera C1 is not limited to the imaging range RN1. For example, in a case where the range of the detection of the event is designated in advance according to an input operation of a mouse MT by the observer who handles the monitor client SV described later, the stationary camera C1 detects the predetermined event (for example, a presence or absence of the motion of the specific object or the face of the specific person) in the designated range of the detection, and does not detect the predetermined event in the range other than the designated range. The detailed description of an internal configuration of the stationary camera C1 is provided below with reference to FIG. 2.

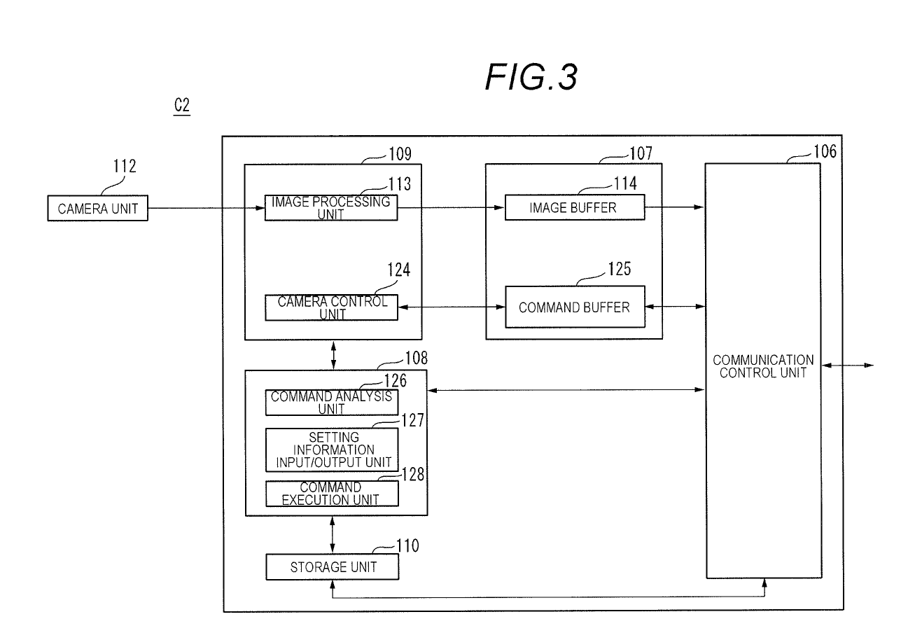

The omni-directional camera C2 has an angle of view where the imaging range is the omni-direction of the imaging area AR from the ceiling surface of the space (for example, a room) of the imaging area AR, and images the omni-directional video corresponding to the angle of view. In this embodiment, the imaging range of the omni-directional camera C2 is substantially the same as the imaging area AR. Thus, the imaging range of the omni-directional camera C2 may be referred to as an omni-directional imaging area or simply as the imaging area AR. The omni-directional camera C2 transmits the omni-directional video data of the image obtained by imaging to the network disk recorder DR via the router RT1. An internal configuration of the omni-directional camera C2 will be described below in detail with reference to FIG. 3.

The router RT1 relays the transmission and reception of the information or the data of the stationary camera C1, the omni-directional camera C2, and the network disk recorder DR. Since the operation of the router RT1 is a well known technology, the description thereof will be omitted.

The network disk recorder DR as an example of the image processing apparatus receives and stores the respective image data generated from images captured by the stationary camera C1 and the omni-directional camera C2, and further, in a case where the notice indicating that the predetermined event is detected is received from the stationary camera C1, the network disk recorder DR transmits the respective image data item generated from the images captured by the stationary camera C1 and the omni-directional camera C2 to the monitor client SV via the network NW.

In addition, in a case where image data generated from an image captured by the omni-directional camera C2 is transmitted to the monitor client SV, the network disk recorder DR may convert the image data generated from the image captured by the omni-directional camera C2 (that is, the omni-directional image data) to wide area plane image data (panorama image data) according to predetermined setting information, and then may transmit the panorama image data to the monitor client SV.

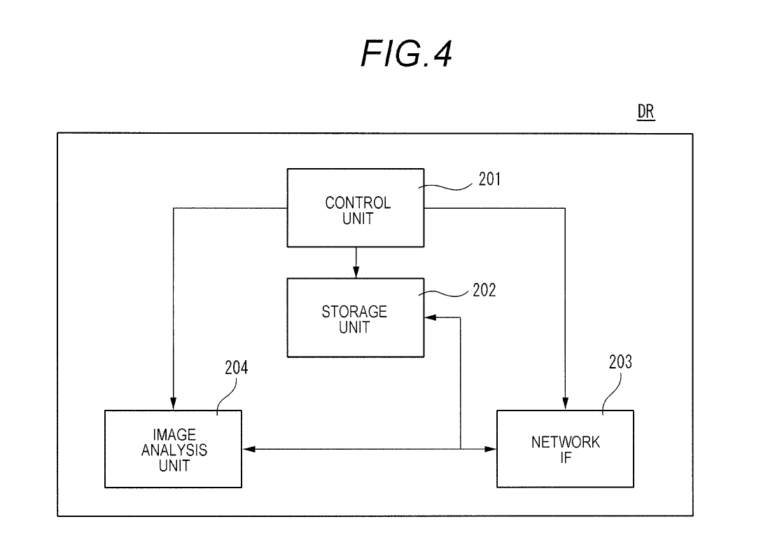

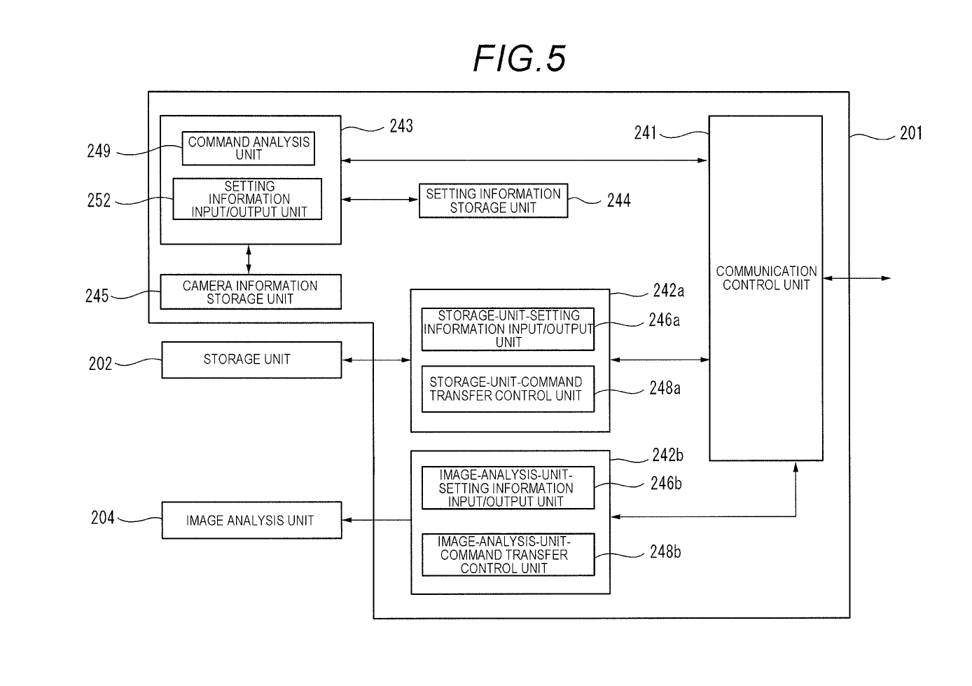

The predetermined setting information is setting information used for the network disk recorder DR to perform an image conversion from the omni-directional image data to the panorama image data. For example, the setting information indicates a position of both ends (for example, the coordinates) or a range (for example, an area) of the panorama image data at the time of panorama conversion processing. The setting information may be stored in the network disk recorder DR in advance, or may be stored in the network disk recorder DR according to an input operation using the mouse MT by the observer of the monitor client SV, for example. The internal configuration of the network disk recorder DR will be described below in detail with reference to FIG. 4 and FIG. 5.

The router RT2 relays the transmission and receiving of the information and data between the network disk recorder DR and the monitor client SV via the network NW. Since the operation of the router RT2 is a known technology, the description thereof will be omitted.

The monitor client SV is an operational terminal operated by the observer of the monitoring system 1000, and for example, is configured of a personal computer (PC). Monitoring application software for the observer to view the monitoring result in the monitoring system 1000 is executably installed in the monitor client SV. Further, the monitor client SV includes a display DP as an example of the display unit and the mouse MT that receives the input operation of the observer. The monitor client SV displays the image data transmitted from the network disk recorder DR (that is, the image data FX1 generated from the image captured by the stationary camera C1 and the omni-directional image data AU generated from the image captured by the omni-directional camera C2) on the predetermined display areas FXWD and ALWD in the basic screen WD1 described below, the event screen WD2, and the search screen WD3.

In FIG. 1, the monitor client SV and the network disk recorder DR are connected via the network NW. However, the monitor client SV may be connected to the network disk recorder DR directly without being connected to the network NW. In this case, the network disk recorder DR and the monitor client SV are physically connected by the wired cable, for example.

In addition, in order to make the description simple, the monitoring system 1000 in the present embodiment is described with a configuration including one stationary camera C1 and one omni-directional camera C2. However, the stationary camera C1 is not limited to one, and the configuration may include a plurality of stationary cameras.

### (Description of Stationary Camera)

FIG. 2 is a block diagram illustrating an internal configuration of the stationary camera C1 in the present embodiment in detail. The stationary camera C1 illustrated in FIG. 2 includes a communication control unit 6, a buffering unit 7, a control unit 8, a processing unit 9, a storage unit 10, a camera unit 12, and a focus controller 22.

The communication control unit 6 performs the transmission and receiving of the information (including a command as a control instruction, hereinafter, the same) or the data between the router RT1 and the communication control unit 6, and distributively outputs the information or the data transmitted from the router RT1 to the buffering unit 7, the control unit 8, or the storage unit 10 according to the content thereof.

The buffering unit 7 temporarily stores the information or the data output from the communication control unit 6, and the image data captured by the camera unit 12 and generated by an image processing unit 13 of the processing unit 9 and having an angle of view of imaging range RN1.

The control unit 8 includes, for example, a central processing unit (CPU), a micro processing unit (MPU), or a digital signal processor (DSP) as hardware resources, reads a program stored in the storage unit 10, and executes each function. For example, the control unit 8 reads a command from the information output from the communication control unit 6 or reads and analyzes a command temporarily stored in the buffering unit 7 then executes a program according to the command, and performs the input and output to and from the storage unit 10 in order to store the setting information of the stationary camera C1.

The processing unit 9 performs the control instruction (command) according to the camera control information temporarily stored in the buffering unit 7, and performs a predetermined signal processing with respect to an electric signal of the image captured by the camera unit 12 to generate and store the image data in the buffering unit 7 in the order.

The storage unit 10 is configured, for example, using a read only memory (ROM), a random access memory (RAM), and a non-volatile memory. A program stored in the ROM or the non-volatile memory of the storage unit 10 is read out to the RAM and is sequentially processed.

The camera unit 12 is configured using, for example, a lens, an image sensor (for example, charged coupled device (CCD) or a complementary metal oxide semiconductor (CMOS)), and a control circuit. The camera unit 12 captures external light and performs a photoelectric conversion on the light transmitted through the lens, and outputs an RGB signal or a complementary color signal by an electronic shutter or performing an exposure time control.

The image processing unit 13 generates and temporarily stores the image data corresponding to a predetermined compression standard in an image buffer 14, by executing a predetermined signal processing (for example, a conversion to a brightness signal Y, color difference signal U and V, a contour correction, a y correction processing) using the RGB signal or the complementary color signal output from the camera unit 12.

In addition, the image processing unit 13 detects the presence or absence of the above-described predetermined event in the image data of the imaging range RN1 or of a part of imaging range which is designated by the monitor client SV out of the imaging range RN1. The information of the imaging range RN1 is, for example, stored in the storage unit 10 as the setting information of the stationary camera C1. When the predetermined event is detected, the image processing unit 13 temporarily stores the notice indicating that the event is detected, in the image buffer 14, and outputs the notice indicating that the event is detected, to the communication control unit 6. The communication control unit 6 transmits the notice indicating that the event is detected by the stationary camera C1 to the network disk recorder DR.

The focus controller 22 performs a focusing processing to perform focusing on the predetermined distance with respect to the angle of view of the imaging range RN1 according to the instruction from the camera control unit 24.

The camera control unit 24 controls the operational instruction to the focus controller 22 or other input and output operations according to the instruction from the control unit 8.

A command buffer 25 temporarily stores the data of the camera control command transmitted from the monitor client SV in order to perform the control operation in the camera control unit 24 or other input and output operations.

A command analysis unit 26 analyzes the command for controlling the stationary camera C1.

A setting information input/output unit 27 performs the setting of the resolution of the stationary camera C1 or the imaging range RN1, and setting of the other setting information.

A command execution unit 28 executes the command analyzed by the command analysis unit 26. For example, in a case where the content of the command is an acquisition of the image data with respect to the stationary camera C1, the command execution unit 28 instructs the image processing unit 13 to acquire the image data.

### (Description of Omni-Directional Camera)

FIG. 3 is a block diagram illustrating an internal configuration of an omni-directional camera C2 in the present embodiment in detail. The omni-directional camera C2 illustrated in FIG. 3 includes a communication control unit 106, a buffering unit 107, a control unit 108, a processing unit 109, a storage unit 110, and a camera unit 112. The communication control unit 106 performs the transmission and receiving of the information (including a command as a control instruction, hereinafter, the same) or the data between the router RT1 and the communication control unit 106, and distributively outputs the information or the data transmitted from the router RT1 to the buffering unit 107, the control unit 108, or the storage unit 110 according to the content thereof.

The buffering unit 107 temporarily stores the information or the data output from the communication control unit 106, and the omni-directional image data generated from the image captured by the camera unit 112 and generated by the image processing unit 113 of the processing unit 109 and has an omni-directional angle of view of imaging area AR. The omni-directional image data is an example of image data in omni-directional imaging range, and a panorama image data in which the omni-directional image is converted into a plane image (panorama image) described below is also included in examples of the image data in the omni-directional imaging range. That is, in this description, although the image captured by the omni-directional camera C2 ranges in an omni-direction, the image data generated from the image captured by the omni-directional camera C2, or the image data related to the omni-direction does not necessarily include the range of the omni-direction, but may include a part of the omni-direction.

The control unit 108 includes, for example, a CPU, an MPU, or a DSP as hardware resources, reads a program stored in the storage unit 110, and executes each function. For example, the control unit 108 reads a command from the information output from the communication control unit 106 or reads and analyzes a command temporarily stored in the buffering unit 107 then executes the program according to the command, and performs the input and output to and from the storage unit 110 in order to store the setting information of the omni-directional camera C2.

The processing unit 109 performs the control instruction (command) according to the camera control information temporarily stored in the buffering unit 107, and performs a predetermined signal processing with respect to an electrical signal of the image captured by the camera unit 112 to generate and store the panorama image data which is the omni-directional image data or the panorama converted omni-directional image data in the buffering unit 107 in the order.

The storage unit 110 is configured, for example, using a read only memory (ROM), a random access memory (RAM), and a non-volatile memory. A program stored in the ROM or the non-volatile memory of the storage unit 110 is read out to the RAM and is sequentially processed.

The camera unit 112 is configured using, for example, a lens, an image sensor (for example, a CCD or a CMOS), and a control circuit, captures external light and performs a photoelectric conversion on the light transmitted through the lens, and outputs an RGB signal or a complementary color signal by an electronic shutter or performing an exposure time control.

The image processing unit 113 generates and temporarily stores the omni-directional image data or the panorama image data corresponding to a predetermined compression standard and in an image buffer 114, by executing a predetermined signal processing (for example, a conversion to a brightness signal Y, color difference signals U and V, a contour correction, a γ correction processing) using the RGB signal or the complementary color signal output from the camera unit 112.

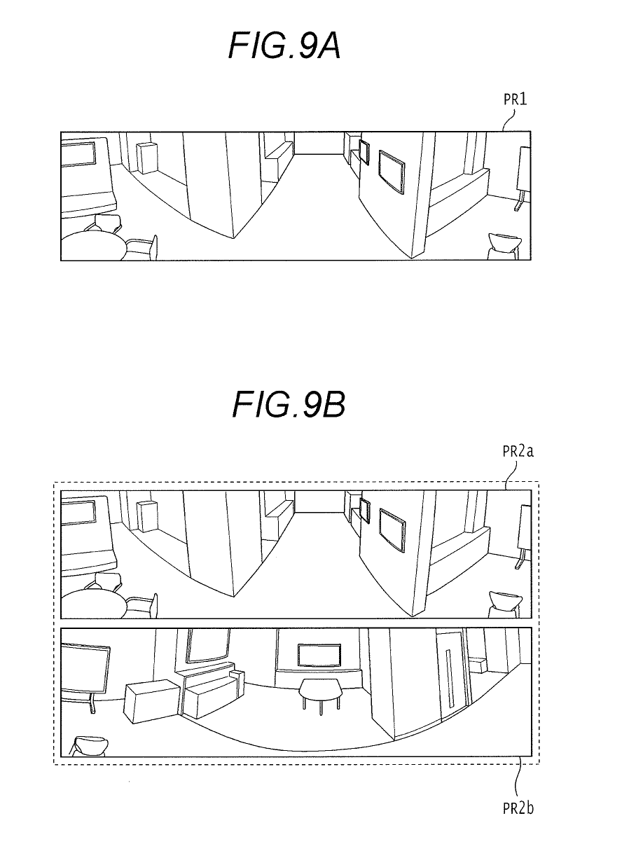

In a method of generating the panorama image data, the image processing unit 113, in a case where the panorama conversion is performed using the omni-directional image data, generates one panorama image data item PR1 (refer to FIG. 9A) in which the imaging range RN1 of the stationary camera C1 is included in the display range (for example, at center), with citing a technology disclosed in WO 2006/022630 A2. In addition, the image processing unit 113, in a case where the panorama conversion is performed using the omni-directional image data, generates two panorama image data items PR2a and PR2b in which omni-direction of the imaging area AR is divided into two. The imaging range RN1 of the stationary camera C1 is included in one panorama image data item out of the two panorama image data items PR2a and PR2b. Furthermore, the panorama image data may be generated by the omni-directional camera C2 or may be generated by the image analysis unit 204 of the network disk recorder DR described below.

The camera control unit 124 controls the operational instruction to the image processing unit 113 or other input and output operations according to the instruction from the control unit 108.

A command buffer 125 temporarily stores the data of the camera control command transmitted from the monitor client SV in order to perform the control operation in the camera control unit 124 or other input and output operations.

A command analysis unit 126 analyzes the command for controlling the omni-directional camera C2.

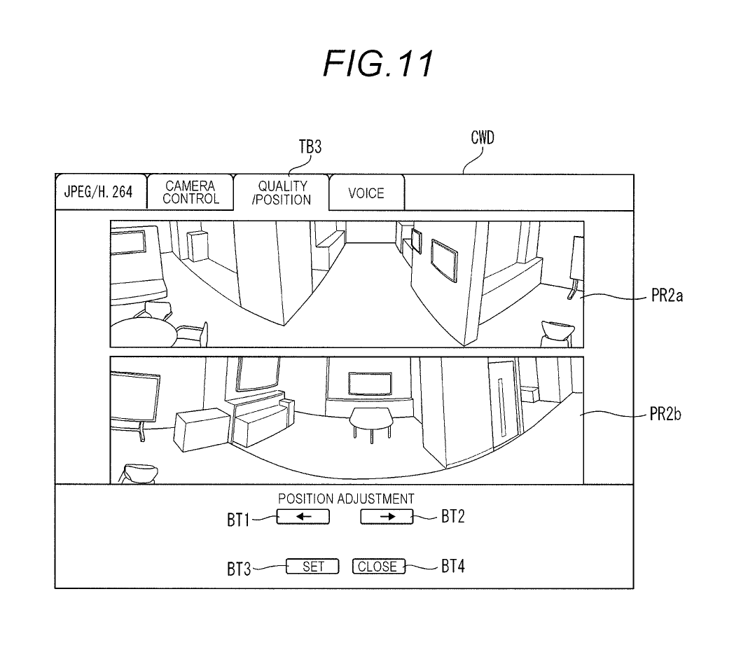

A setting information input/output unit 127 performs the setting of the resolution of the omni-directional camera C2 or the imaging range, and the setting information of the positions of both ends of the panorama image data set in a camera setting screen WD5 (refer to FIG. 11), and setting of other setting information. A command execution unit 128 executes the command analyzed by the command analysis unit 126. For example, in a case where the content of the command is an acquisition of the omni-directional image data with respect to the omni-directional camera C2 or the panorama image data, the command execution unit 128 instructs the image processing unit 113 to acquire the omni-directional image data or the panorama image data.

In addition, the omni-directional camera C2, in a case where the request for displaying of the camera setting screen WD5 (refer to FIG. 11) is received in the communication control unit 106 from the monitor client SV, causes the camera setting screen WD5 as an example of an input screen of the setting range to be displayed on the display DP of the monitor client SV as a graphical user interface (GUI) via the communication control unit 106.

FIG. 11 is a diagram illustrating an example of the camera setting screen. In the camera setting screen WD5 illustrated in FIG. 11, in the tab TB3 of image quality/position, two panorama image data items PR2a and PR2b in which the panorama image data generated by the panorama conversion of the omni-directional image data of the imaging area AR captured by the omni-directional camera C2 is divided into two and displayed. In addition, on the lower side of the panorama image data PR2b on the camera setting screen WD5, a left adjustment button BT1, a right adjustment button BT2, a setting button BT3, and a closing button BT4 for adjusting the positions of both ends of the panorama image data are displayed.

For example, when the observer who handles the monitor client SV clicks the right adjustment button BT2 (or left adjustment button BT1) of the camera setting screen WD5 using the mouse MT, the notice indicating that the click operation of the right adjustment button BT2 (or left adjustment button BT1) is performed is transmitted to the omni-directional camera C2 from the monitor client SV. Then, the omni-directional camera C2 generates the panorama image data PR2a and PR2b in which the right end (or left end) of the panorama image data PR2a and PR2b is slightly shifted to the right (or left) to be displayed on the display DP of the monitor client SV. In this way, on the camera setting screen WD5, the observer can view the desired panorama image data PR2a and PR2b and can properly adjust both ends at the time of panorama conversion by the simple operation of such as operating the left adjustment button BT1 or the right adjustment button BT2 for adjusting the positions of both ends of the panorama image data.

### (Description of Network Disk Recorder)

FIG. 4 is a block diagram illustrating a hardware configuration of the network disk recorder DR in the present embodiment. The network disk recorder DR as an example of an image processing apparatus illustrated in FIG. 4 includes a control unit 201, a storage unit 202, a network interface (IF) 203, and an image analysis unit 204.

The control unit 201, for example, is configured using a CPU, an MPU, and a DSP, integrally controls the operation of each unit of the network disk recorder DR, and performs a predetermined signal processing, input and output controls or storage control of information and data. A detailed software configuration of the control unit 201 will be described below with reference to FIG. 5. The storage unit 202 stores image data of the imaging range RN1 transmitted from the stationary camera C1 and image data related to the omni-direction transmitted from the omni-directional camera C2 (specifically, the omni-directional image data or the panorama image data).

The network IF 203 receives and stores the image data of the imaging range RN1 transmitted from the stationary camera C1 and the image data related to the omni-direction transmitted from the omni-directional camera C2 (specifically, the omni-directional image data or the panorama image data) in the storage unit 202. In addition, the network IF 203 outputs the image data related to the omni-direction transmitted from the omni-directional camera C2 (specifically, the omni-directional image data or the panorama image data) to the image analysis unit 204.

The image analysis unit 204 performs a motion detection processing of a specific object and a face detection processing of a specific person, using the image data in the imaging range RN1 captured by the stationary camera C1 or in a designated range designated by the input operation of the observer who handles the monitor client SV.

With regard to the motion detection processing in the image analysis unit 204, as a technology of tracking an object used for determining the duration of a moving object, for example, U.S. Pat. No. 8,243,180 or Japanese Patent No. 5210841 can be cited.

In addition, with regard to the face detection processing in the image analysis unit 204, for example, a technology disclosed in “Robust Real-time Object Detection, Paul Viola & Michael Jones, Second International Workshop On Statistical and Computational Theories Of Vision-Modeling, Learning, Computing, and Sampling, Jul. 13, 2001”, or a technology named as “Face Recognition” disclosed in the Internet web page URL: www.biometrics.gov/Documents/FaceRec.pdf can be cited. Those technologies may be used in the image processing unit 13 of the stationary camera C1.

In the image data of the image range RN1 captured by the stationary camera C1 or of the designated range designated by the input operation of the observer who handles the monitor client SV, in a case where an event related to a motion detection of a specific object is detected, the image analysis unit 204 transmits the detection result (including the image data, hereinafter, the same) related to the motion detection of the specific object to the monitor client SV via the network IF 203. In addition, in the image data of the image range RN1 captured by the stationary camera C1 or of the designated range designated by the input operation of the observer who handles the monitor client SV, in a case where an event related to a face detection of a specific person is detected, the image analysis unit 204 transmits the detection result (including the image data, hereinafter, the same) related to the face detection of the specific person to the monitor client SV via the network IF 203.

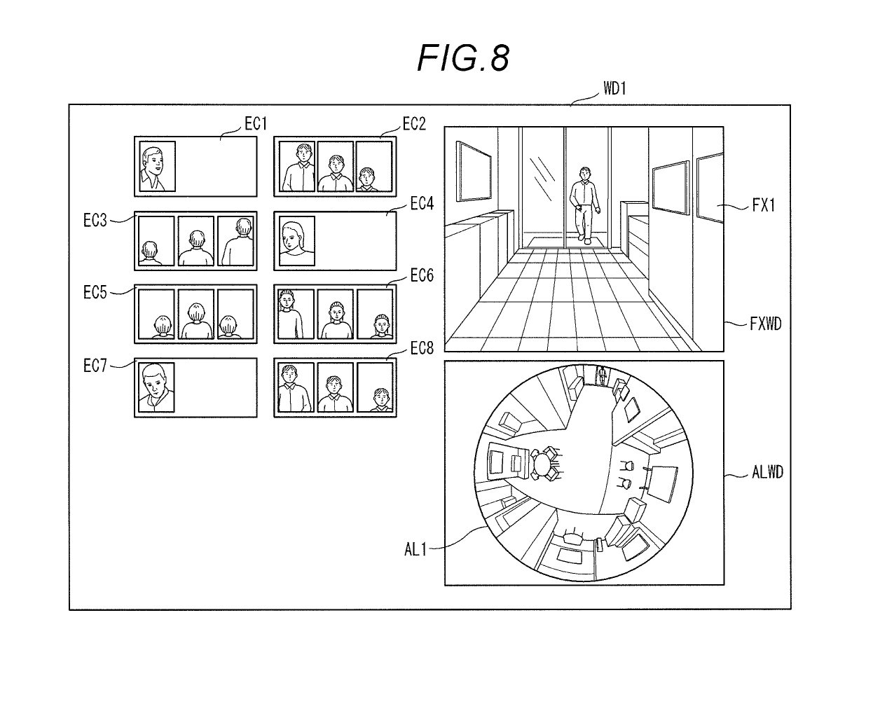

In addition, in the image data of the image range RN1 captured by the stationary camera C1 or of the designated range designated by the input operation of the observer who handles the monitor client SV, in a case where an event related to a motion detection of a specific object is detected, the image analysis unit 204 transmits the image data captured by the stationary camera C1 and the omni-directional image data captured by the omni-directional camera C2 at the time when the event is detected, to the monitor client SV via the network IF 203. The monitor client SV displays the captured data FX1 and AL1 respectively captured by the stationary camera C1 and the omni-directional camera C2 at the time when the event is detected, for example, on the corresponding display region FXWD and ALWD on the basic screen WD1 of the application software for monitoring (refer to FIG. 8).

In this way, in the monitoring system 1000 in the present embodiment, in a case where the event is detected in the image data generated from the image captured by the stationary camera C1, since the video of the surrounding environment including the imaging range of the stationary camera C1 is captured by the omni-directional camera C2, it is possible for the observer to easily check how the target (for example, the face of the specific person or the motion of the specific object) which causes the detected event will move. Therefore. in a case where the event is detected, the monitoring system 1000 can easily indicate the relationship visually between the surrounding environment of the monitoring target object which causes the event at the time of monitoring and the monitoring target object.

In addition, in the image data of the image range RN1 captured by the stationary camera C1 or of the designated range designated by the input operation of the observer who handles the monitor client SV, in a case where an event related to a motion detection of a specific object is detected, the image analysis unit 204 cuts out and stores the video data including the image data captured by the stationary camera C1 from the start of detection of the motion of the specific object to the end of detection in the storage unit 202.

In addition, in order to visually indicate to the observer the notice indicating that the video data including the image data captured by the stationary camera C1 from the start of detection of the motion of the specific object to the end of detection is stored in the storage unit 202, the image analysis unit 204 generates event card data that includes date and time information in which the event is detected using the video data including the image data generated from the image captured by the stationary camera C1 from the start of detection of the motion of the specific object to the end of detection.

Specifically, the image analysis unit 204, for example, generates thumbnail image data which is representative image data of at least three time points, of at the time point of start of detection, during the detection, and the end of detection, and further, arranges the thumbnail image data in time-series, to be stored in the storage unit 202. The event card data is generated for each event detected by the image analysis unit 204 to be stored in the storage unit 202.

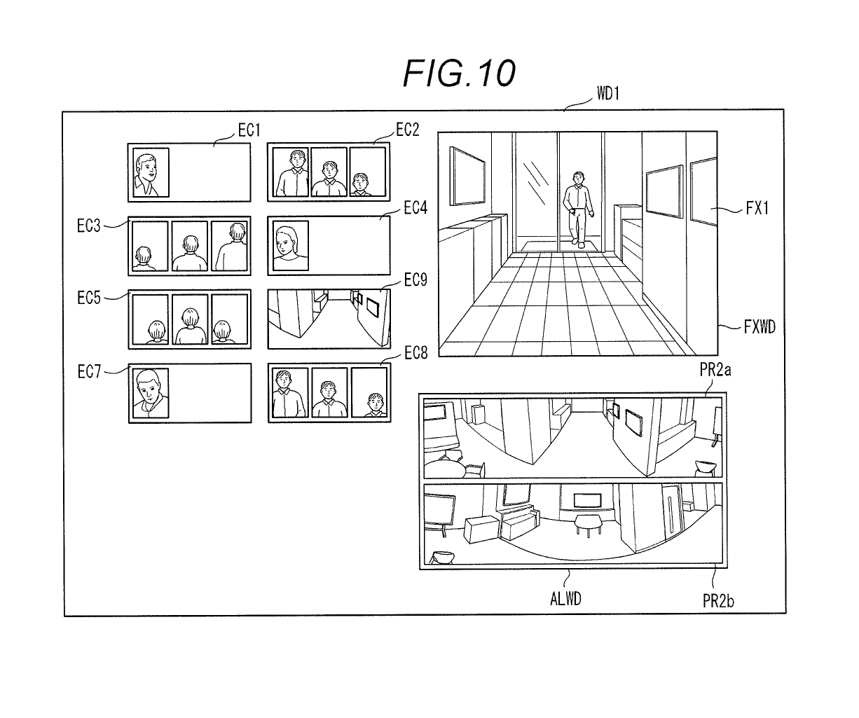

In the event card data, thumbnail image data of the panorama image data in which the image data generated from the omni-directional image captured by the omni-directional camera C2 at the time when the motion of the specific object is detected is panorama converted, may be used (refer to an event card EC9 illustrated in FIG. 10).

After generating the event card data and storing the event card data in the storage unit 202, the image analysis unit 204 transmits the event card data to the monitor client SV via the network IF 203. The monitor client SV displays event cards EC1 to EC8 corresponding to the event card data transmitted from the network disk recorder DR, for example, on the predetermined display area of the basic screen WD1 (for example, display area on the left half side of the basic screen WD1) of the application software for monitoring displayed on the display DP (refer to FIG. 8).

Similarly, in the image data of the image range RN1 captured by the stationary camera C1 or of the designated range designated by the input operation of the observer who handles the monitor client SV, in a case where an event related to a face detection of a specific person is detected, the image analysis unit 204 cuts out and stores the video data including the image data generated from the image captured by the stationary camera C1 from the start of detection of the face of the specific person to the end of detection in the storage unit 202.

In addition, in order to visually indicate to the observer the notice indicating that the video data including the image data generated from the image captured by the stationary camera C1 from the start of detection of the face of the specific person to the end of detection is stored in the storage unit 202, the image analysis unit 204 selects any of the representative image data among the image data generated from the image captured by the stationary camera C1 from the start of detection of the face of the specific person to the end of detection, and generates an event card data.

Specifically, the image analysis unit 204, for example, selects the image data in which the face of the specific person is most identifiable, that is, the image data including the face in which the person can be specified, generates the thumbnail image data of the selected image data, and then, generates the event card data using at least one of the thumbnail image data items, to store the event card data in the storage unit 202.

In addition, on the basic screen WD1 or the event screen WD2 displayed on the display DP of the monitor client SV, in a case where any of the event cards (for example, the event card EC2) is operated (for example, double clicked), the image analysis unit 204 acquires the notice indicating that this operation is performed, via the monitor client SV and the network IF 203, reads the omni-directional image data which is the operation target of the monitor client SV from the storage unit 202, converts the omni-directional image data from the start of detection of the event to the end of detection into the panorama image data, and displays (reproduces) the panorama image data on the display area ALWD of the basic screen WD1 or the event screen WD2.

Next, details of software configuration of the control unit 201 of the network disk recorder DR will be described with reference to FIG. 5. FIG. 5 is a block diagram illustrating the software configuration of the control unit 201 of the network disk recorder DR. The control unit 201 of the network disk recorder DR illustrated in FIG. 5, for example, is configured using a CPU, MPU, or DSP as the hardware resource, and includes a communication control unit 241, a storage-unit-control unit 242a, an image-analysis-unit-control unit 242b, a recorder-control unit 243, a setting information storage unit 244, and a camera information storage unit 245.

The communication control unit 241 performs the transmission or the receiving of the information (including the command as the control instruction, hereinafter, the same) or the data between the router RT1 and the communication control unit 241, and distributively outputs the information or the data transmitted from the router RT1 to the storage-unit-control unit 242a, the image-analysis-unit-control unit 242b, or the recorder-control unit 243 according to the content thereof.

The storage-unit-control unit 242a controls the input and output of the information or data between the storage unit 202 and the storage-unit-control unit 242a, and includes a storage-unit-setting information input/output unit 246a, and a storage-unit-command transfer control unit 248a.

The storage-unit-setting information input/output unit 246a stores the setting information of the stationary camera C1 or the setting information of the omni-directional camera C2 received from the stationary camera C1 or the omni-directional camera C2 by the communication control unit 241 in the storage unit 202.

The storage-unit-command transfer control unit 248a functions as a common gateway interface (CGI) that causes the storage unit 202 to operate, and the communication control unit 241 stores the image data received from the stationary camera C1 or the omni-directional camera C2 (specifically, the image data generated from the image captured by the stationary camera C1 and the omni-directional image data or the panorama image data generated from the omni-directional image captured by the omni-directional camera C2), in the storage unit 202.

The image-analysis-unit-control unit 242b controls the input and output of the information or the data between the image analysis unit 204 and the image-analysis-unit-control unit 242b, and includes an image-analysis-unit-setting information input/output unit 246b and an image-analysis-unit-command transfer control unit 248b.

The image-analysis-unit-setting information input/output unit 246b stores the setting information necessary for the image analysis (image processing) of the image data of the stationary camera C1 received by the communication control unit 241 from the stationary camera C1 or the omni-directional camera C2, in the image analysis unit 204.

The storage-unit-command transfer control unit 248a functions as the common gateway interface (CGI) that causes the storage unit 202 to operate, and the communication control unit 241 stores the image data received from the stationary camera C1 or the omni-directional camera C2 (specifically, the image data generated from the image captured by the stationary camera C1 and the omni-directional image data or the panorama image data generated from the omni-directional image captured by the omni-directional camera C2), in the storage unit 202.

The recorder-control unit 243 includes a command analysis unit 249 and a setting information input/output unit 252. The recorder-control unit 243 controls various operations by analyzing a command based on the information or the data received by the communication control unit 241 from any of the stationary camera C1, the omni-directional camera C2 or the monitor client SV.

The command analysis unit 249 analyzes the command for controlling the network disk recorder DR.

The setting information input/output unit 252 performs a setting processing using the setting information necessary for the operation of the network disk recorder DR.

The setting information storage unit 244 stores the setting information necessary for the operations of the stationary camera C1 and the omni-directional camera C2 connected to the network disk recorder DR. In the setting information related to the stationary camera C1, for example, the information on the angle of view, an installation angle, and the detection target range of the event related to the size of the image data are included. The setting information related to the omni-directional camera C2 includes, for example, the information on the angle of view, an installation angle, and information related to a position of both ends at the time of panorama conversion.

The camera information storage unit 245 stores the camera information of the stationary camera C1 and the omni-directional camera C2 connected to the network disk recorder DR.

### (State Transition of Various Screens Displayed on the Monitor Client)

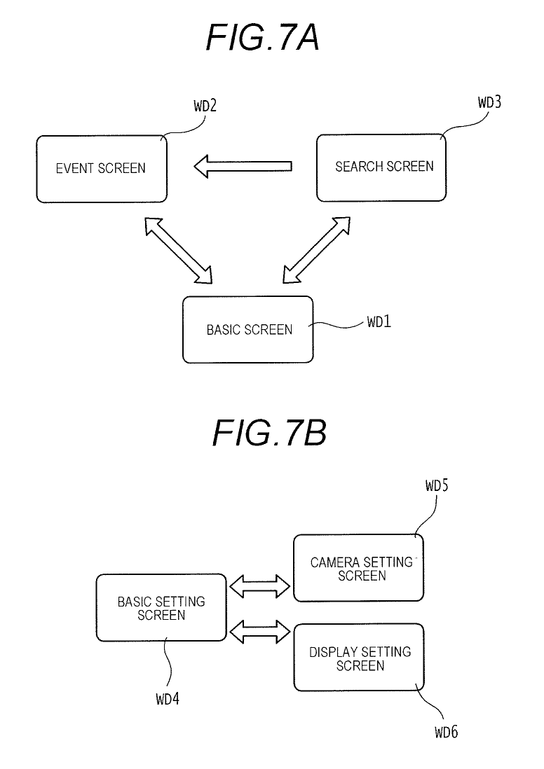

Next, a state transition of various screens displayed on the display DP of the monitor client SV will be described with reference to FIG. 7A and FIG. 7B. FIG. 7A is a diagram illustrating the transition state between the basic screen WD1, and the event screen WD2, and the search screen WD3. FIG. 7B is a diagram illustrating the transition state between a basic set screen WD4, a camera set screen WD5, and a display set screen WD6. FIG. 8 is a diagram illustrating a first example of the basic screen.

As illustrated in FIG. 7A, in the application software for monitoring installed in the monitor client SV, the state transition of the screen displayed on the display DP is performed between the basic screen WD1, and the event screen WD2, and the search screen WD3. In addition, as illustrated in FIG. 7B, the basic set screen WD4 is divided into the camera set screen WD5 and the display set screen WD6.

In the basic screen WD1, a plurality of event cards generated by the network disk recorder DR and arranged in time series, the image data (first image data) generated from the image captured by the stationary camera C1, and the image data (second image data) generated from the omni-directional image captured by the omni-directional camera C2, are displayed (refer to FIG. 8). Specifically in the display area in the left half side of the basic screen WD1 illustrated in FIG. 8, a plurality of event cards EC1 to EC8 are displayed in the time series. In the display area FXWD in the upper right side of the basic screen WD1, the image data (first image data) generated from the image captured at the present time by the stationary camera C1 is displayed. In the display area ALWD in the right lower side of the basic screen WD1, the omni-directional image data (second image data) generated from the image captured at the present time by the omni-directional camera C2 is displayed. The details of content of each event card EC1 to EC8 will be described below.

On the event screen WD2 (not illustrated in detail), similar to the basic screen WD1, a plurality of event cards generated by the network disk recorder DR and arranged in time series, the image data generated from the image captured by the stationary camera C1, and the omni-directional image data generated from the image captured by the omni-directional camera C2, are displayed. Here, when any event card on the event screen WD2 is operated (for example, double clicked), in the display area FXWD on the event screen WD2, the image data generated from the image captured by the stationary camera C1 from the start of detection to the end of detection of the event corresponding to the operation target event card, and furthermore, at this time, in the display area ALWD within the event screen WD2, the omni-directional image data generated from the image captured by the omni-directional camera C2 from the start of detection to the end of detection of the event corresponding to the operation target event card is reproduced and displayed, or the panorama converted panorama image data is reproduced and displayed.

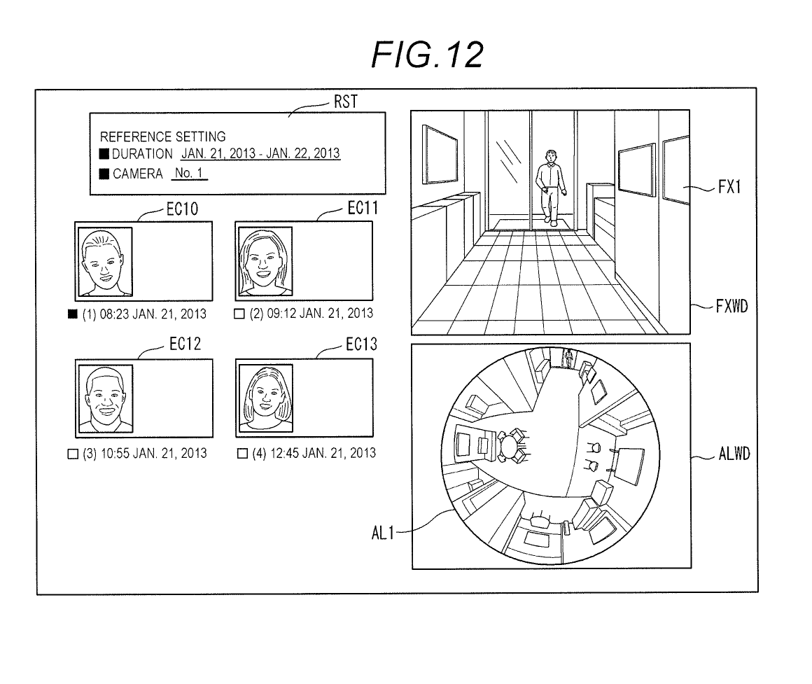

On the search screen WD3 (refer to FIG. 12 described below), a searching condition input box RST to which a searching condition for searching for a searching target event card is input, the event cards EC10 to EC13 which are coincident with the searching condition input to the searching condition input box RST, and the display areas FXWD and ALWD similar to the basic screen WD1 and the event screen WD2 are displayed.

To the searching condition input box RST, a period of a searching target (extraction target) and a parameter of the camera (for example, the stationary camera C1) are input. The event cards EC10 to EC13, for example, are the event cards generated by the event detection in the image data generated from the image captured by a camera 1 (for example, the stationary camera C1) from Jan. 21, 2013 to Jan. 22, 2013, and the event detection date and time (including the year, A.D., hereinafter, the same) are also displayed.

The basic set screen WD4 is divided into two screens of the camera set screen WD5 (refer to FIG. 11) for performing the setting of the stationary camera C1 and the omni-directional camera C2 and the display set screen WD6 (not illustrated in detail). In order to perform the setting of the stationary camera C1 and the omni-directional camera C2, the main setting items of the camera set screen WD5 are setting of the network, an encoding method of the image data, the direction of the omni-directional camera C2, the setting and adjustment of the position information of both ends at the time of panorama conversion, but are not limited thereto. The main setting items of the display set screen WD6 are a name of the stationary camera C1 or the omni-directional camera C2 in a case where the image data is displayed on the display DP of the monitor client SV, a color of the display window, but are not limited thereto.

In the basic screen WD1 illustrated in FIG. 8, the event cards EC1, EC4, and EC7 are event cards generated by the network disk recorder DR in a case where the face of specific person is detected as the event. The event cards EC2, EC3, EC5, EC6, and EC8 are event cards generated by the network disk recorder DR in a case where the motion of the specific object (or person) is detected as the event. The event card EC2 shows the movement of a person moving from the right rear side to the left front side in the imaging range RN1. The event card EC3 shows the movement of a person moving from the left front side to the right rear side in the imaging range RN1. The event card EC5 shows the movement of a person moving from the right front side to the left front side by way of the middle side in the imaging range RN1. The event cards EC6 and EC8 show the movement of a person moving from the left rear side to the right front side in the imaging range RN1.

In addition, in the basic screen WD1 illustrated in FIG. 8, in the display area FXWD in the right upper side, the image data generated from the image captured by the stationary camera C1 is displayed. In the display area ALWD in the right lower side, the omni-directional image data generated from the image captured by the omni-directional camera C2 is displayed. In the display area FXWD, a person passing the door DO is displayed, and the network disk recorder DR detects the motion of the person and generates the event card data using the panorama image data of the omni-directional image data generated from the image captured by the omni-directional camera C2 from the start time of detection to the end time of detection. The generated event card is transmitted to the monitor client SV and is additionally displayed on the left side of the display area of the basic screen WD1. By the operation to the generated event card (for example, double click), the monitor client SV can show the movement status of the person so as to be easily visually understood using the panorama image data of the omni-directional image data generated from the image captured by the omni-directional camera C2 from the start time of detection to the end time of detection of the person in the display area FXWD in the display DP.

FIG. 9A is a diagram illustrating one panorama image data item PR1 generated such that an imaging range RN1 of the stationary camera C1 is included in the display range as a modification example of omni-directional image data. FIG. 9B is a diagram illustrating two panorama image data items PR2a and PR2b generated such that the imaging range RN1 of the stationary camera C1 is included in the display range as a modification example of omni-directional image data. One panorama image data item PR1 illustrated in FIG. 9A is generated by the image analysis unit 204 of the network disk recorder DR such that the imaging range RN1 (refer to FIG. 6) of the stationary camera C1 is included. In addition, any one of the two panorama image data items PR2a and PR2b illustrated in FIG. 9B is generated by the image analysis unit 204 of the network disk recorder DR such that the imaging range RN1 (refer to FIG. 6) of the stationary camera C1 is included.

FIG. 10 is a diagram illustrating a second example of the basic screen WD1. The difference between the basic screen WD1 illustrated in FIG. 10 and the basic screen WD1 illustrated in FIG. 8 will be described. In the basic screen WD1 illustrated in FIG. 10, an event card EC9 is displayed instead of the event card EC6 in the basic screen WD1 illustrated in FIG. 8. In addition, in the display area ALWD of the omni-directional image data generated from the image captured by the omni-directional camera C2, two panorama image data items PR2a and PR2b which are panorama converted are displayed. In the event card EC9, as the event card generated by the network disk recorder DR in a case where the motion of the specific person is detected as the event, the thumbnail image data of the panorama image data based on the omni-directional image data captured by the omni-directional camera C2 is used. Since there is no other difference between the basic screens WD1 in FIG. 8 and FIG. 10, further description will be omitted.

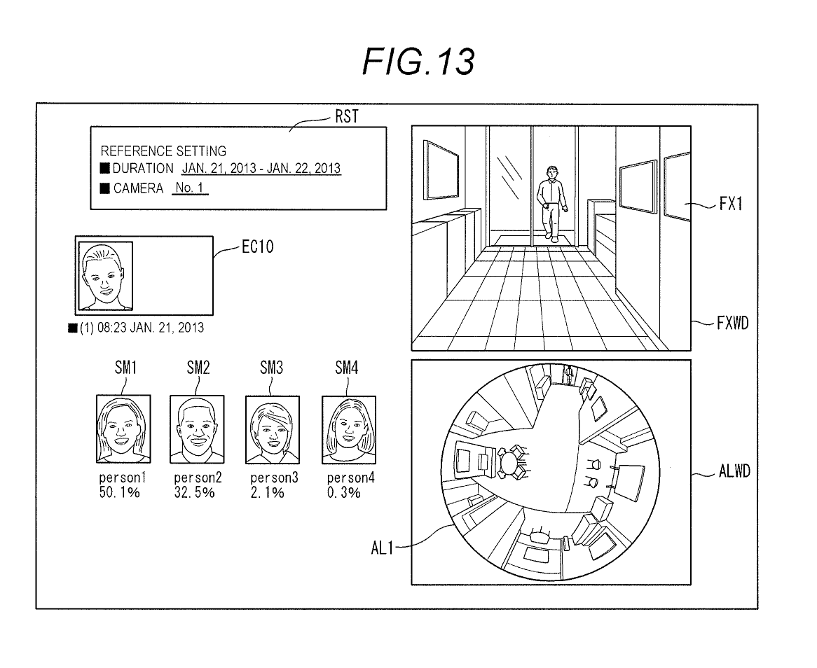

Next, the search screen WD3 displayed on the display DP of the monitor client SV will be described with reference to FIG. 12 and FIG. 13. FIG. 12 is a diagram illustrating a first example of the search screen WD3. FIG. 13 is a diagram illustrating a second example of the search screen WD3.

In the display area on the upper left side of the search screen WD3 illustrated in FIG. 12, the searching condition input box RST to which the searching condition for searching for the searching target event card is input, is displayed. When the duration of a searching target and the condition of the camera are designated in the searching condition input box RST of the search screen WD3 and the search button (not illustrated) is selected, the image analysis unit 204 of the network disk recorder DR, in a case where the event card data which is coincident with the searching condition is present referring to the event card data stored in the storage unit 202, transmits one or more event card data items to the monitor client SV via the network IF 203.

The monitor client SV displays the one or more event card data items transmitted from the network disk recorder DR on the display area on the lower side of the searching condition input box RST of the search screen WD3. In FIG. 12, the event cards EC10 to EC13 are the event cards generated by the event detection in the image data generated from the image captured by a camera 1 (for example, the stationary camera C1) from Jan. 21, 2013 to Jan. 22, 2013.

The event card EC10 is the event card generated according to the event detection (for example, the face detection of the person) at 08:23 on Jan. 21, 2013. The event card EC11 is the event card generated according to the event detection (for example, the face detection of the person) at 09:12 on Jan. 21, 2013. The event card EC12 is the event card generated according to the event detection (for example, the face detection of the person) at 10:55 on Jan. 21, 2013. The event card EC13 is the event card generated according to the event detection (for example, the face detection of the person) at 12:45 on Jan. 21, 2013.

In FIG. 12, the four event card EC10 among the event cards EC10 to EC13 is selected as a reference by the input operation of the mouse MT of the observer who handles the monitor client SV.

In addition, in the search screen WD3 illustrated in FIG. 12, when a person shown in the event card EC10 is selected as the reference, the monitor client SV transmits the notice indicating that the person shown in the event card EC10 is selected as the reference to the network disk recorder DR. When the network disk recorder DR receives the notice indicating that the person shown in the event card EC10 is selected as the reference from the monitor client SV, the network disk recorder DR reads the omni⁻directional image data at the time of face detection of the person shown in the event card EC10 or the predetermined time including the detection time from the storage unit 202, and detects the face of one of the same person or one or more other persons (hereinafter, referred to as “relevant person”) existing in the omni-directional image data at a plurality of other times when the face of the person selected as the reference is detected, in the image analysis unit 204.

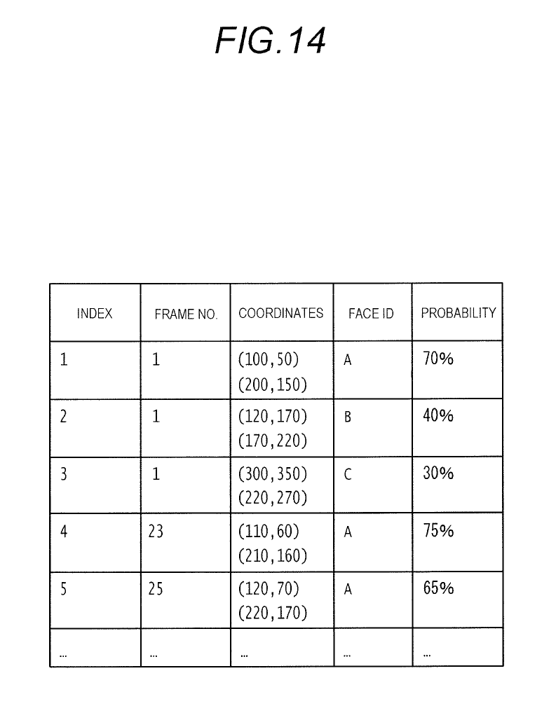

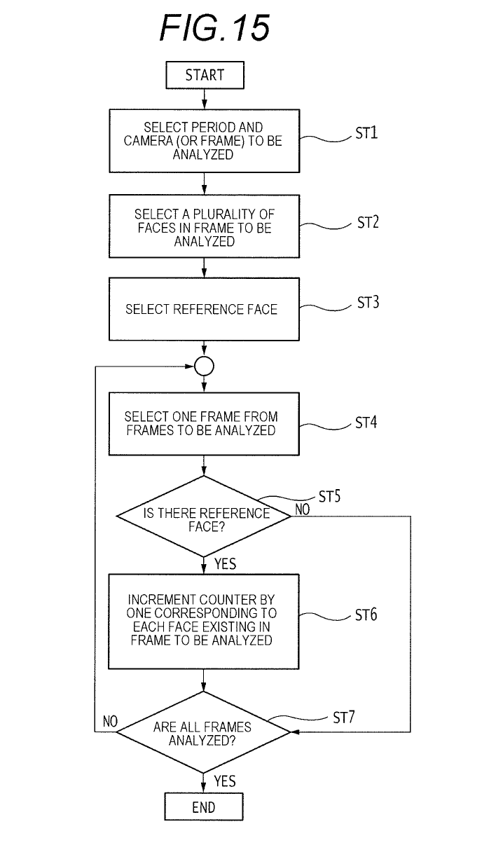

Furthermore, the image analysis unit 204 in the network disk recorder DR calculates the degree of relevance between the person shown in the event card EC10 and one or more relevant persons detected by the image analysis unit 204. A plurality of methods can be considered for calculating the degree of relevance, and an example thereof will be described below with reference to FIG. 14 and FIG. 15.

In addition, the image analysis unit 204 calculates the degree of relevance, for example, based on the rate of the imaging time of the face of the person indicated in the event card EC10 and the imaging time of the face of the person described above. Alternatively, the image analysis unit 204 calculates the degree of relevance based on the distance between the face of the person indicated in the event card EC10 and the face of the relevant person described above in the omni-directional image data or in the panorama image data, or the distance in real space.

The network disk recorder DR, in a case where the face of the relevant person can be detected, cuts out the image data of the face of one of the same person or one or more other persons existing in the omni-directional image data at a plurality of other times when the face of the person selected as the reference, to transmit the image data to the monitor client SV.

As a result, on the display area on the lower side of the searching condition input box RST of the search screen WD3 illustrated in FIG. 13, the event card EC10 selected as a reference is displayed firstly, and further, on the display area on the lower side of the event card EC10, the thumbnail image data SM1 to SM4 of the relevant person transmitted from the network disk recorder DR, and the degree of relevance (for example, a proportion of appearing at the same time) between each of the persons and the persons indicated in the event cards EC10, are displayed.

Specifically, the degree of relevance between the person (person 1) indicated in the thumbnail image data SM1 and the person indicated in the event card EC10 selected as a reference is 50.1%. The degree of relevance between the person (person 2) indicated in the thumbnail image data SM2 and the person indicated in the event card EC10 selected as a reference is 32.5%. The degree of relevance between the person (person 3) indicated in the thumbnail image data SM3 and the person indicated in the event card EC10 selected as a reference is 2.1%. The degree of relevance between the person (person 4) indicated in the thumbnail image data SM4 and the person indicated in the event card EC10 selected as a reference is 0.3%.

In a case where the thumbnail image data SM1 to SM4 of a plurality of relevant persons are displayed on the display area in the lower side of the event card EC10 of the search screen WD3, the monitor client SV sorts the thumbnail image data SM1 to SM4 in a descending order or an ascending order of the degree of relevance to display the thumbnail image data. In this way, the observer can easily check the face of the relevant person in the order of high relationship or low relationship with the face of the person selected as a reference, and thus, it is possible to improve the efficiency of the monitoring task.

Here, the method of calculating the degree of relevance between the face of the person selected as a reference and the face of the relevant person by the image analysis unit 204 of the network disk recorder DR will be described with reference to FIG. 14 and FIG. 15. FIG. 14 is an example of a table showing the face detection results with respect to the omni-directional image data. FIG. 15 is a flow chart explaining an operation order for calculating the degree of relevance of the image analysis unit in detail.

In a case where the image analysis unit 204 of the network disk recorder DR detects the face of a specific person with respect to the image data generated from the image captured by the stationary camera C1, the table illustrated in FIG. 14 may be generated by the image analysis unit 204 and stored in the storage unit 202, or may be temporarily stored in the RAM (not illustrated) of the network disk recorder DR. An index is a number indicating a record of the table, a frame number is a frame number of the image data generated from the image captured by the stationary camera C1, coordinates are information indicating the position of the face of the specific person detected in the frame corresponding to the frame number, a face ID is identification information assigned to each face of the detected person, and a probability is a parameter obtainable as a detection result of the face detection of the image analysis unit 204 and indicates the probability of the face being the face corresponding to the face ID.

For example, the face of a person having the face ID of “A” is detected in a rectangle shown by the coordinates (100, 50) to (200, 150), a rectangle shown by the coordinates (110, 60) to (210, 160), and a rectangle shown by the coordinates (120, 70) to (220, 170) in the frame of three frames having frame Nos. 1, 23, and 25, with the probability of “70%”, “75%”, and “65%” respectively.

In addition, in the frame having the frame No. 1, the face of the person corresponding to the face IDs “A”, “B”, and “C” is detected in a rectangle shown by the coordinates (100, 50) to (200, 150), a rectangle shown by the coordinates (120, 170) to (170, 220), and a rectangle shown by the coordinates (300, 350) to (220, 270) in the frame with the probability of “70%”, “40%”, and “30%” respectively. In addition, even though it is not illustrated in FIG. 14, the date and time when the face detection processing is executed is registered in this table by the image analysis unit 204 of the network disk recorder DR.

In FIG. 15, the monitor client SV receives the input of the period and the camera number (or the frame number (not illustrated)) of the searching target in the searching condition input box RST (refer to FIG. 12) of the search screen WD3 displayed on the display DP (ST1) by the input operation with the mouse MT of the observer.

After receiving the input of the period and the camera number (or the frame number (not illustrated)) of the searching target in the searching condition input box RST (refer to FIG. 12) of the search screen WD3, the monitor client SV transmits the searching condition information of the period and the camera number of the searching target to the network disk recorder DR.

The network disk recorder DR outputs the searching condition information of the period and the camera information of the searching target to the image analysis unit 204 when receiving the searching condition information of the period and the camera number of the searching target from the monitor client SV. The image analysis unit 204 extracts at least one image data item (frame) that satisfies the searching condition information based on the searching condition information of the period and the camera information of the searching target and the omni-directional image data or the panorama image data stored in the storage unit 202. Furthermore, the image analysis unit 204 performs the face detection processing of the person with respect to the extracted image data (ST2), and generates the table illustrated in FIG. 14 using the face detection processing result for each image data item which is subject to the face detection processing.

In a case where the face detection processing of the person with respect to the extracted image data has already been performed and the event card data corresponding to the face detection processing result of the person is stored in the storage unit 202, the image analysis unit 204 may omit the face detection processing of the person in STEP ST2. The image analysis unit 204 generates the event card data using the face detection result of the person in the image data that satisfies the searching condition information, and transmits the event card data to the monitor client SV via the network IF 203.

The monitor client SV displays the event card (for example, event cards EC10 to EC13) corresponding to the searching condition information input in STEP ST1 using the event card data transmitted from the network disk recorder DR, on the display area on the lower side of the searching condition input box RST of the search screen WD3 displayed on the display DP (refer to FIG. 12).

The monitor client SV receives the selection of the event card as a reference among the event cards EC10 to EC13 of the search screen WD3 displayed on the display DP, by the input operation with the mouse MT of the observer (ST3). For example, in STEP ST3, the face of the person shown in the event card EC10 is assumed to be selected. The monitor client SV transmits the information related to the event card EC10 selected as a reference to the network disk recorder DR.

When the information related to the event card EC10 transmitted from the monitor client SV is received, the network disk recorder DR outputs the information related to the event card EC10 selected as a reference to the image analysis unit 204. The image analysis unit 204 selects any of image data from at least one image data item extracted in STEP ST2 (ST4).

The image analysis unit 204 determines whether the face of the person shown in the event card EC10 selected as a reference is detected or not from the image data selected in STEP ST4 (ST5). In a case where the face of the person shown in the event card EC10 selected as a reference is detected from the image data selected in STEP ST4 (YES in ST5), the image analysis unit 204 increments by one the counter corresponding to the face of each person detected in the image data selected in STEP ST4 (ST6).

The counter assigned in STEP ST6 is a parameter indicating the number of detections that the face of each person is detected in the image data selected as a target for the face detection processing of the image analysis unit 204. If the counter corresponding to the face of each person is increased, it indicates that the face appears frequently together with the face of the person selected as a reference. On the other hand, if the counter is closer to zero, it indicates that the face does not appear so frequently together with the face of the person selected as a reference.

After analyzing the one frame among the frames to be analyzed, i.e., if the image analysis unit 204 determines that the face of the person shown in the event card EC10 selected as a reference is not detected from the image data selected in STEP ST4 (NO in ST5) or when the STEP ST 5 is completed, the image analysis unit 204 determines whether all of the frames has been analyzed or not (ST7). If all of the frames has been not analyzed (NO in ST7), the image analysis unit 204 repeats the operation for the next frame in STEP ST4. In a case where the image analysis unit 204 has finished analyzing all of the image data (frame) extracted in STEP ST2 (YES in ST7), the process in the flow chart illustrated in FIG. 15 ends.

The image analysis unit 204 calculates, for example, the degree of relevance between the person of the face ID “A” illustrated in FIG. 14 and the person selected as a reference as follows. Specifically, the image analysis unit 204 calculates the degree of relevance between the person selected as a reference and the person of the face ID “A” by a rate of a summed value of the probability of the person of the face ID “A” in the image data (frame) from which the face of the person selected as a reference is detected and the number of image data items (frame) from which the face of the person selected as a reference is detected.

For example, the image analysis unit 204 calculates the degree of relevance between the person selected as a reference and the person of the face ID “A” as {(70%+75%+65%)/3}=70% with reference to the table illustrated in FIG. 14.

In this way, in the monitoring system 1000 in the present embodiment, the stationary camera C1 captures the image in the predetermined imaging range RN1, the omni-directional camera C2 captures the image related to the omni-directional imaging area including the predetermined imaging range RN1, the network disk recorder DR detects the predetermined event in the image data in the predetermined imaging range RN1, and the display DP of the monitor client SV displays the image data generated from the images captured by the stationary camera C1 and the omni-directional camera C2.

In addition, in a case where the predetermined event in the predetermined imaging range RN1 is detected, the monitor client SV displays the image data generated from the image captured by the stationary camera C1 and the image data (for example, the omni-directional image data or the panorama image data) generated from the image in the omni-directional imaging area including the predetermined imaging range RN1 from which the event is detected, on the display DP.

In this way, in the monitoring system 1000, in a case where the event is detected in the image data generated from the image captured by the stationary camera C1, since the video of the surrounding environment including the imaging range RN1 of the stationary camera C1 is captured by the omni-directional camera C2, it is possible for the observer to easily check how the target (for example, the face of the specific person or the motion of the specific object) which causes the detected event will move. Therefore, in a case where the event is detected, the monitoring system 1000 can easily indicate the relationship visually between the surrounding environment of the monitoring target object which causes the event at the time of monitoring and the monitoring target object.

As described above, various embodiments are described with reference to the drawings. However, it is needless to say that the present invention is not limited to the described examples. It is apparent that various changed examples and modification examples can be made by those skilled in the art, within the scope of the invention, and it is understood that those changed examples and modification examples will also be included in the technical range of the present invention.

The present invention is useful, in a case where the event is detected, for the monitoring system that can easily indicate the relationship visually between the surrounding environment of the monitoring target object which causes the event at the time of monitoring and the monitoring target object.

What is claimed is:

1. A monitoring system, comprising:
a stationary camera that captures an image in a predetermined imaging range;
an omni-directional camera that captures an image in an omni-directional imaging area including the predetermined imaging range;
an image processing apparatus that detects a predetermined event in first image data, wherein the first image data is generated from the image in the predetermined imaging range captured by the stationary camera; and
a display unit that displays image data, wherein
in a case where the predetermined event is detected in the predetermined imaging range of the first image data, the display unit displays the first image data and second image data, wherein the second image data is generated from the image in the omni-directional imaging area captured by the omni-directional camera and includes the predetermined imaging range from which the predetermined event is detected.

2. The monitoring system according to claim 1, wherein
the omni-directional camera or the image processing apparatus generates the second image data that includes plane image data having a predetermined display range based on the image in the omni-directional imaging area captured by the omni-directional camera.

3. The monitoring system according to claim 2, wherein
the display unit displays the plane image data having the predetermined display range in which the predetermined imaging range captured by the stationary camera is included.

4. The monitoring system according to claim 2, wherein
the plane image data includes first and second divided plane image data generated by dividing the omni-directional imaging area into two areas,
a display range of the first or second divided plane image data includes the predetermined imaging range captured by the stationary camera, and
the display unit displays the first and second divided plane image data.

5. The monitoring system according to claim 2, wherein
the display unit displays a setting range input screen for causing a display range of the plane image data to be set, and
the omni-directional camera or the image processing apparatus generates the plane image data based on the display range set on the setting range input screen according to an input operation with respect to the setting range input screen.

6. The monitoring system according to claim 1, wherein
the image processing apparatus detects, as the predetermined event, a motion of a specific object in the predetermined imaging range of the first image data.

7. The monitoring system according to claim 1, wherein
the image processing apparatus detects, as the predetermined event, a face of a specific person in the predetermined imaging range of the first image data.

8. The monitoring system according to claim 6, wherein
the image processing apparatus detects the motion of the specific object in an area designated with respect to the display unit in the predetermined imaging range of the first image data.

9. The monitoring system according to claim 7, wherein
the image processing apparatus detects the face of the specific person in an area designated with respect to the display unit in the predetermined imaging range of the first image data.

10. The monitoring system according to claim 6, further comprising:
a storage unit that stores video data for each predetermined event, wherein the video data includes the first image data generated from the image captured by the stationary camera from a start of detecting the motion of the specific object to an end of detecting the motion of the specific object. wherein
the display unit displays an event card which indicates a storage of the video data stored for each predetermined event.

11. The monitoring system according to claim 10, wherein
the display unit displays, as the event card, a plurality of thumbnail image data items at a different time points from the start of detecting the motion of the specific object to the end of detecting the motion of the specific object.

12. The monitoring system according to claim 10, wherein
the display unit displays, as the event card, thumbnail image data of the plane image data with the display range having the predetermined imaging range captured by the stationary camera from the start of detecting the motion of the specific object to the end of detecting the motion of the specific object.

13. The monitoring system according to claim 11, wherein
the display unit reproduces the plane image data generated based on the omni-directional image data by the omni-directional camera from the start of detecting the motion of the specific object to the end of detecting the motion of the specific object according to an operation of the event card.

14. The monitoring system according to claim 7, further comprising:
a storage unit that stores video data for each predetermined event, wherein the video data includes the first image data generated from the image captured by the stationary camera from a start of detecting the face of the specific person to an end of detecting the face of the specific person, wherein
the display unit displays an event card which indicates a storage of the video data stored for each predetermined event.

15. The monitoring system according to claim 7, wherein
in a case where the image processing apparatus detects a face of a first person in the first image data, the image processing apparatus detects a face of a second person existing in the second image data at a plurality of different time points from a time point when the face of the first person is detected, and
the display unit displays image data of the face of the first person detected from the first image and image data of the face of the second person detected from the second image.

16. The monitoring system according to claim 7, wherein
in a predetermined time period including the time point when a face of a first person is detected in the first image data, the image processing apparatus detects a face of a second person existing in the second image data at a plurality of time points different from a time point when the face of the first person is detected, and
the display unit displays image data of the face of the first person detected from the first image data and image data of the face of the second person detected from the second image data.

17. The monitoring system according to claim 7, wherein
the image processing apparatus detects the face of the second person that exists at the same time as the detected face of the first person based on the image data related to the omni-direction captured by the omni-directional camera, and
the display unit displays a degree of relevance between the first person and the second person based on an imaging time of the face of the first person and an imaging time of the face of the second person.

18. The monitoring system according to claim 7, wherein
the image processing apparatus detects a face of a second person based on the second image data, the second person existing at a same time as a face of a first person detected from the first image data, and
the display unit displays a degree of relevance between the first person and the second person based on a distance between the first person and the second person.

19. The monitoring system according to claim 7, wherein
the image processing apparatus detects faces of a plurality of other persons based on the second image, the plurality of other persons existing in same image data in which the face of the first person designated with respect to the display unit exists, and
the display unit displays the faces of the plurality of other persons in an order determined based on a degree of relevance between the face of the designated first person and the faces of the plurality of other persons.
